(19) United States
(12) Patent Application Publication
(10) Pub. No.: US 2008/0102191 A1
(43) Pub. Date: May 1, 2008

(54) FLAVORED SKEWER

(76) Inventors: Howard Munt, Lawrenceville, NJ (US); Debbie Lu, Kendall Park, NJ (US); Audrey Wiggins, Eastampton, NJ (US)

Correspondence Address: WINSTON & STRAWN LLP;PATENT DEPARTMENT, 1700 K STREET, N.W., WASHINGTON, DC, 20006, US

(21) Appl. No.: 11/961,732

(22) Filed: Dec. 20, 2007

Related U.S. Application Data
(63) Continuation of application No. PCT/IB2006/052276, filed on Jul. 6, 2006.
(60) Provisional application No. 60/698,947, filed on Jul. 14, 2005.

(51) Int. Cl. A23L 1/22; A47J 37/04; A23P 1/08

(52) U.S. Cl. 426/650; 99/419; 426/420

(57) ABSTRACT

The present invention relates to flavored skewers suitable for grilling, frying or roasting pieces of meat, fish, chicken, vegetables or other food. The skewers have a coating that includes flavors which are preferably microencapsulated. Once skewered on the skewer, the food is flavored from the inside. The skewers of the present invention may be used to flavor foods intended for grilling instead of or supplemental to classic marinades.

### CROSS-REFERENCE TO RELATED APPLICATION(S)

This application is a continuation of International application PCT/IB2006/052276 filed on Jul.6, 2006, and claims the benefit of U.S. provisional application No. 60/698,947 filed on Jul. 14, 2005, the entire content of each of which is expressly incorporated herein by reference thereto.

### TECHNICAL FIELD

The present invention relates to skewers comprising a coating with flavors. The invention further relates to a method for preparing a skewer and to a method for flavoring foods prepared by barbecuing, grilling, frying, broiling, griddling and/or roasting. The invention also relates to the use of skewers for flavoring food.

### BACKGROUND OF THE INVENTION

Foods such as meat, fish, shellfish and vegetables often have flavor added to them by seasoning or marinating. In the process of marinating, a sauce containing flavor or seasoning is prepared and the food is then brought into contact with the sauce over a prolonged time, allowing the flavors to diffuse from the surface to the interior of the food.

One drawback of this way of flavoring is the time lost for preparing a marinade or seasoning and marinating or coating the food. With some marinades, this may require several hours or more for the flavor to permeate the food, which does not fit well with the concept of spontaneous barbecuing in the open air.

Another drawback is that the flavors are applied from the outer surface of a given piece of food only, which may result in burning, flaring and/or evaporating during cooking.

A different method of flavoring solid foods is given in U.S. Pat. No. 2,116,310 where a skewer is coated with flavor and then inserted into meat. To apply the flavoring, the skewers are simply steeped in a flavoring solution. The disadvantage is that desirable volatile flavors will often be lost prior to insertion of the skewer into the meat.

In U.S. Pat. No. 5,922,377, a rod for flavoring food has flavoring means, such as dried spices, herbs or vegetables on its surface and a binder consisting essentially of partially hydrogenated cotton seed oil, partially hydrogenated soybean oil and soybean lecithin for releasably binding the flavoring means to the rod. This is a complicated system and is limited insofar as the binder is not suitable for binding liquid flavors.

The present invention now addresses one or more of the problems and provide one or more of the desired benefits mentioned above.

### SUMMARY OF THE INVENTION

Accordingly, the present invention provides a skewer for flavoring solid foods comprising a coating on at least a portion of the outer surface of the skewer, whereby the coating comprises an encapsulated flavor.

The present invention also provides a method for preparing a skewer, the method comprising the step of applying a coating comprising an encapsulated flavor to at least a portion of the outer surface of the skewer.

The present invention further provides a method of flavoring food, the method comprising the step of skewering the food onto the skewer defined above.

According to another aspect, the present invention provides the use of a skewer comprising a coating on at least a portion of the outer surface of the skewer for flavoring food, wherein the coating comprises an encapsulated flavor.

### BRIEF DESCRIPTION OF THE DRAWINGS

FIG. 1 shows a comparison of flavor quantity of grilled chicken flavored at iso-load by way of a TIC (Total Ion Chromatogram) of volatiles present in breath during eating.

FIG. 2 shows maximum intensity of a specific flavor compound (Citral) in the breath of two panelists during eating.

### DETAILED DESCRIPTION OF THE PREFERRED EMBODIMENTS

The term “skewer” in the context of the present invention, means any utensil which is suitable for piercing solid food. Typically, a skewer is in the form of a rod, a pin, a pick, a spit, a stick or the like. The skewer will typically comprise a single rod though skewers comprising more than one rod are also within the scope of the invention. The skewer of the invention is suitable to skewer all kinds of solid food. Preferably, the phrase “solid food” denotes any food which is capable of being carried on a skewer. The skewer of the present invention may be made of any suitable material or of combinations of different materials. Examples include wood, plastic, metal, porcelain and glass. Preferably, it is made of wood. Generally, the skewer of the present invention is not limited by its size, but preferably has a length in the range of about 5 to about 100 cm, more preferably about 10 to about 50 cm. The diameter of the skewer is preferably in the range of about 0.8 mm to about 15 mm, more preferably about 1.5 to about 9 mm.

The skewer of the invention may have any suitable cross-section, e.g. a circular, oval or rectangular cross-section.

The term “flavor” encompasses compounds, ingredients and/or compositions, which are used alone or in combination with other compounds, to impart a desired gustative effect, in particular to a food product and/or a beverage. To be considered as a flavor, it must be recognized by a person skilled in the art as being able to modify in a desired way the taste of a composition. Such compositions are intended for oral consumption and are hence often foods, nutritional compositions and the like.

The textbook “Perfume and Flavor Chemicals” Steffen Arctander, published by the author, 1969, is a collection of perfumes and flavors known to the skilled person and is expressly incorporated herein in its entirety by reference. The molecules of this textbook and its later editions are suitable for being used as flavors in the present invention. The term flavor also includes compounds that are perceived by mediation of the trigeminal nerve, such as cooling, salivating, pungent and tingling compounds, for example.

The coating used in the present invention may be fat-based, water-based or may be present in the form of an emulsion. If the coating is fat-based, the fat or mixture of fats used for the coating is preferably solid a room temperature. In a preferred embodiment of the invention, the coating is water-based. A water-based coating is defined as a coating which, during its preparation comprises at least about 10 wt. %, preferably at least about 20 wt. %, more preferably at least about 30 wt. % and most preferably at least about 50 wt. % of water, based on the total weight of the coating. It is worthwhile noting that when the coating is on the skewer, the water preferably evaporates and is no longer detectable in substantial amounts on the skewer.

In a preferred embodiment, the coating on the skewer comprises a film-forming material. A film-forming material, for the purpose of the present invention, is a material that is capable of increasing the adherence of a liquid to the skewer. Therefore, depending on the material of the skewer, a film-forming material may be selected that is capable of attaching flavors to the skewer. The skilled person is capable of selecting suitable film forming materials, which may be selected from may different kinds of subject matter, such as proteins, carbohydrates and other, generally polymeric, ingredients. Preferably, the film-forming material is a water-soluble carbohydrate, more preferably a water-soluble oligo- and/or polysaccharide. The term “water soluble carbohydrate” means that the carbohydrate is at least 50% soluble according to the method described by L. Prosky et al., J. Assoc. Off. Anal. Chem. 71, 1017-1023 (1988).

Suitable film-forming materials may be selected amongst gums, such as pullulan gum, gum arabic, locust bean gum, carrageenan, guar gum, gum acacia, gum tragacanth, gum ghatti, karaya gum, xanthan, agar, furcellaran and Danish agar.

Other film-forming materials may be used. Examples are such as alginate with or without calcium or sodium, pectin or mixtures of different pectins with all grades of methoxylation, methylcellulose, hydroxypropylcellulose, carboxymethylcellulose, starches and modified starches, amylose, amylopectin, proplyengylcol alginate, propyleneglycol, tamarind flour, arabinogalactan, scleroglucan and polyvinylpyrrolidon (PVP).

All ingredients may be used alone or in combination with other ingredients having the same or similar functions.

The flavors are encapsulated. The encapsulation of flavors is particularly advantageous in the context of the present invention, in order to prevent preliminary loss of generally volatile flavor compounds by evaporation from the coating on the skewer. The present inventors surprisingly found that by coating the skewer with a coating comprising encapsulated flavors, the flavors are retained on the skewer until food is skewered onto it followed by preparation in the presence of heat or moisture. In this way, all the flavors used in the coating will diffuse and/or move into the food from the inside of the food. Encapsulated flavors provide further important advantages since the flavors are retained in the capsules on the skewer and are not lost through evaporation. This is of particular importance in case the skewer has to be dried, for example after applying the coating onto it. Additionally, the flavors have a longer shelf-life than non-encapsulated flavors. A further advantage is that encapsulation allows for both solid and liquid flavors to be used in the present invention thus giving a greater choice of flavors from which to select.

The flavors may be encapsulated by any method known in the art, but according to a preferred embodiment, the flavors are encapsulated in capsules selected from the group consisting of spray-dried capsules, extruded capsules, spray-granulated capsules, spray-coated (with fat or wax, for example) capsules, spray-agglomerated capsules, coacervates, core-shell capsules made by prilling, cyclodextrin encapsulated flavors (molecular inclusion), In Situ Micro Encapsulation (ISME), and yeast based capsules.

Preferably, the flavors of the present invention are encapsulated in microcapsules. Microcapsules are defined, for the purpose of the present invention, as capsules having a arithmetic mean diameter in the range of about 600 nm to about 500 μm.

In a preferred embodiment, the flavors are encapsulated in a micro-organism, preferably yeast cells. Microencapsulation of flavors in yeast cells is disclosed in the literature, Bishop J R P, Nelso G, Lamb J “Microencapsulation in yeast cells”, Microencapsulation, 1998, vol. 15, no. 6, 761-73. See also CA 2470351 and EP 0528466 and EP A2 0242135.

The flavors may be encapsulated in a micro-organism as follows. In a first step, the micro-organism is mixed with water to produce an aqueous mixture comprising a suspension of 10-30 wt. % solids. Emulsifiers, surfactants and/or stabilizers are optionally added to the aqueous liquid. The flavor, which is preferably hydrophobic, is then added to the mixture.

The mixtures can be in the form of a suspension, a slurry, an emulsion, or a dispersion. An emulsion is preferred. Preferably the emulsion is simply maintained by agitation.

Preferably, the dry-weight ratio of micro-organism to flavor in the mixture is in the range of about 1:1 to about 5:1, preferably about 1.4:1 to about 4:1, more preferably about 1.6:1 to about 3:1.

The mixture is then mixed, stirred or agitated for about 1 to about 6, preferably about 1.5 to about 5 hours, preferably at above-ambient temperatures, such as above about 35° C., or even above about 40° C.

During the mixing step, at least part of the flavor may defuse into the cell of the micro-organism.

Following the more or less complete diffusion of the flavor into the cells of the micro-organism, the encapsulated micro-organisms may be dried. Examples of suitable drying techniques include spray drying, freeze drying, fluidized bed drying and/or oven drying. Spray drying is preferred.

Alternatively, further dry-matter, hereinafter referred to as matrix material, may be added prior to drying. Matrix material may be selected from carbohydrates and proteins, for example. Preferably, water-soluble matrix materials are used. Preferably, the matrix material is a starch or starch derived product, such as hydrolyzed or otherwise chemically modified starch. Preferably, the matrix material is maltodextrin.

Preferably, 0.6 to 2 parts of matrix material are added for every part of micro-organism added earlier in dried form.

After adding the matrix component to the aqueous liquid, all components are preferably mixed again, for example by using a high shear mixer, in order to ensure proper homogenisation. Then, the resulting mixture is dried, and, if desired (depending on the drying technology applied) granulated.

Encapsulation of flavors in micro-organisms according to the above process are disclosed in co-pending applications WO-A-2005/067733 and WO-A-2006/006003.

The method for preparing the skewer of the invention comprises the step of applying a coating comprising the encapsulated flavor to the skewer.

The coating may be applied in any way onto the skewer. For example, the coating may be applied simply by dipping a commercially available skewer into a liquid comprising the encapsulated flavors, the liquid adhering at least to some extent to the skewer. Alternatively, the coating liquid may be sprayed on or applied with a brush.

In one aspect, the method of preparing a skewer further comprises the step of preparing a coating by dissolving and/or suspending the encapsulated flavors in a liquid. Accordingly, water, oils/fats or other lipids such as waxes, or emulsions may be used as liquids. Preferably the liquid is aqueous.

In a preferred embodiment, the coating is prepared by further adding a film forming material to the liquid.

Preferably, encapsulated flavors, usually in the form of powdered compositions or granulates, are added to a liquid for preparing a coating for the purpose of the present invention. For example, the capsules may be entrapped in capsules having an arithmetic mean diameter of about 500 nm to about 1000 μm, more preferably about 700 nm to about 700 μm, most preferably about 800 nm to about 500 μm. Accordingly, the capsules are preferably microcapsules, being defined as capsules having a mean diameter of about 600 nm to about 500 μm.

The encapsulated flavors are preferably added to the liquid at about 0.1 to about 35%, more preferably about 5 to about 25% of capsules, based on the total weight of the liquid. In these percentages, the total weight of capsules including pure flavors is referred to.

Where a film-forming material is added to the liquid, it may be present in an amount of from about 90 to about 1% of film forming material in percent by weight of the sum of liquid and film forming material together.

A water-based coating may be prepared by mixing about 10 to about 99wt. % water and about 90 to about 1 wt. % of a film-forming material. More preferably, the water based-coating comprises about 50 to about 90 wt. % water and about 10 to about 50 wt. % film-forming material. Most preferably, the coating comprises about 70 to about 85 wt. % water and about 15 to about 30 wt. % film-former.

The coating preferably comprises further food ingredients. Examples of further food ingredients that are beneficially used in the coating include spices, NaCl and/or other salt-tasting ingredients, chili powders, acids, phosphates, herb powders and taste enhancers. Of course, these ingredients may also be present in encapsulated form. These additives are not considered for calculating the percentages given in the present description, as they are used at the discretion of the skilled person.

Further additives may be added to the coating, such as solvents, emulsifiers, stabilizers and preservatives. Similarly, these additives are not considered for calculating the percentages given in the present description.

Once the coating is applied to the skewer, the skewers may be dried, for example at room temperature (25° C.) or at higher temperatures, if necessary. Drying is preferred if water is used to prepare the coating.

The food skewered on the skewer of the invention may be cooked, eaten in the raw state, marinated (for example with an acid) or smoked, for example, before consumption. For example, fish and other protein-rich food may be eaten in the raw state or treated with an acid (vinegar, citrus juice, wine, etc) to denature proteins. Such food may also be skewered on the skewer of the invention and the flavors of the coating will contribute to the flavor impact of the food. Preferably, the food is cooked. Preferably, the method of flavoring food further comprises the step of cooking the food by barbecuing, grilling, frying, broiling, griddling and/or roasting.

The food may be cooked immediately afterwards or after waiting for some time, for example about 1 minute to about 12 hours. Of course, marinated/seasoned food may also be skewered, in order to apply flavors from the inside and the outside of the food.

### EXAMPLES

The following examples are intended to illustrate the invention without limiting the scope as a result. Percentages or parts are expressed by weight, unless otherwise indicated.

### Example 1

### Encapsulation of Flavors

A commercially available flavor solution was encapsulated in micro-organisms according to the following procedure: 100 g spray-dried yeast (DHW, Germany) was dispersed in 375 g water. 75 g of a lemon flavor composition (ex Firmenich SA, Switzerland) was added and the mixture maintained for 4 hours at 50° C. under constant agitation at 150 rpm in a blade stirrer.

Thereafter, 150 g of maltodextrin (DE 18) was added and mixed until the total aqueous mixture was homogenous.

The mixture was then spray dried on a Niro mobile minor® at 210° C. inlet and 90° C. outlet temperature at a feed rate of 10 ml/minute. A powder of microcapsules based on a micro-organism, a matrix component and at least one flavor was obtained. The resulting flavor capsules comprised 40 wt. % yeast, 40 wt. % maltodextrin and 20 wt. % liquid flavor.

The same procedure was repeated with the same amount of a pepper flavor (black pepper oil). The yeast-encapsulated flavors prepared according to the present example are commercially available from Firmenich SA, Switzerland under product numbers 885007 TTB0440 and 885009 TTB0440.

### Example 2

### Preparation of Skewer with Flavored Coating

A coating was prepared in the form of an adhesive edible film.

| | |
|---|---|
| Hot Water | 79.16% |
| *Pullalan Gum PI 20 | 19.80% |
| Glycerin | 0.99% |
| #Tween 80 | 0.05% |

*ex Hayashibara Company, LTD
#Polyoxyethylene(20)sorbitan monooleate

In a clear glass beaker, glycerine and Tween 80 were blended together. Hot water (80° C.) was added to the beaker and mixed thoroughly. Pullulan gum was slowly added into the water and stirred until all of it had dissolved. A clear and very viscous liquid was obtained.

The microcapsules obtained in example I were added to the viscous coating at 19% by weight, based on the total weight of viscous liquid and microcapsules.

The coating was manually smeared onto the skewer with a fingertip. Once the skewer was evenly coated, it was left to air dry for 12 hours or until the adhesive (coating) hardened.

### Example 3

### Preparation of Flavored Food and Sensory Analysis

Flavor compositions were applied to chicken in four different ways for comparative study. After cooking on the grill for 2-3 minutes at 165° F. (73.8° C.), the cooked chicken was evaluated sensorially and instrumentally.

Pieces of chicken (50 g) were flavored at iso-active levels of lemon and pepper flavors (see example 1). Flavors were present in encapsulated form (example 1) and in liquid form (commercially available). Flavors were applied to sticks according to the procedure in example 2, using microencapsulated or liquid flavors directly. Furthermore, flavors were applied to the surface of the chicken in the form of a marinade based on corn oil and either encapsulated or liquid flavor. The flavor compositions applied at iso-load to each piece of chicken and the way of application is given below:

A) Yeast-encapsulated flavors in coating on skewer at 0.5 g of coating per stick. The surface of the chicken was rubbed with 3 g oil and 0.3 g salt. The coating was prepared by mixing the following components:

| | Wt. % |
|---|---|
| Viscous coating⁽¹⁾ | 70.42 |
| Microcapsules with lemon flavor⁽²⁾ | 19.01 |
| Citric acid | 3.53 |
| Microcapsules with black pepper oil⁽²⁾ | 7.04 |

⁽¹⁾preparation; see example 2
⁽²⁾see example 1

B) Liquid flavors in coating on skewer at 0.5 g per stick. The surface of the chicken was rubbed with 3 g oil and 0.3 g salt. The coating was prepared by mixing the following components:

| | Wt. % |
|---|---|
| Viscous coating⁽¹⁾ | 91.27 |
| Liquid lemon flavor⁽³⁾ | 3.80 |
| Citric acid | 3.53 |
| Black pepper oil⁽³⁾ | 1.40 |

⁽³⁾source of liquid flavors as given in example 1

C) Marinade on surface of chicken with yeast-encapsulated flavors at 3.447 g of marinade put on the surface. The marinade was prepared by mixing the following components:

| | Wt. % |
|---|---|
| Corn Oil | 87.047 |
| Salt | 8.700 |
| Microcapsules with lemon flavor⁽²⁾ | 2.750 |
| Citric acid | 0.493 |
| Microcapsules with black pepper oil⁽²⁾ | 1.010 |

D) Marinade on surface of chicken with liquid flavors at 0.343 g of marinade put on the surface. The marinade was prepared by mixing the following components:

| | Wt. % |
|---|---|
| Corn Oil | 89.745 |
| Salt | 8.970 |
| Liquid lemon flavor⁽³⁾ | 0.568 |
| Citric Acid | 0.508 |
| Black Pepper Oil⁽³⁾ | 0.209 |

All samples (A, B, C, D) were tasted three times by two panelists. The panelists found that flavors applied as coating on the skewer before grilling produced the most intense flavors.

APCI-MS (Atmospheric Pressure Chemical Ionization Mass Spectrometry) as disclosed in U.S. Pat. No. 5,869,344 was used for instrumental evaluation. This equipment measures the content of total or specific volatiles present in breath exhaled through the nose by way of a breathing tube, which is in communication with the nostril of a panelist. Briefly, the quantity (intensity) of ionized volatiles may be determined for compounds characterized by their molecular weight by guiding breath of the nasal cavity containing a complex mixture of volatiles to a mass spectrometer (MS). The measurement takes place during eating.

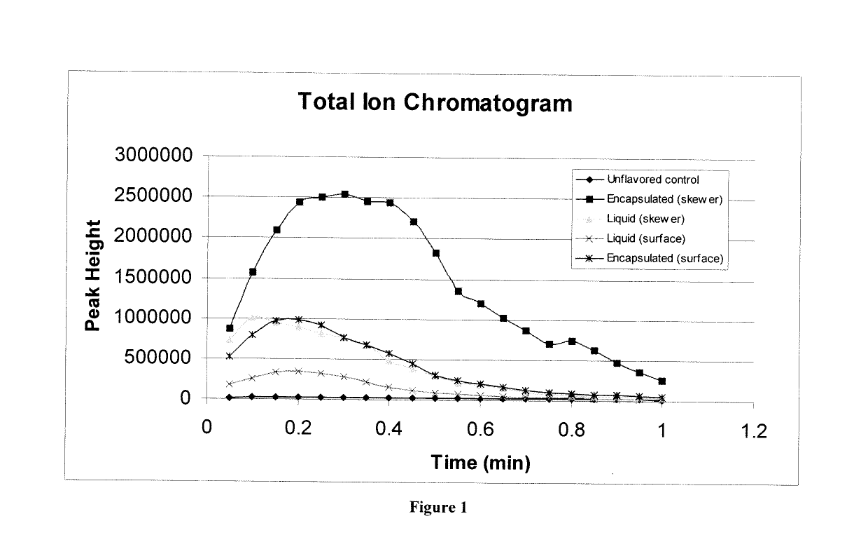

The results in FIG. 1 show that encapsulated flavors coated on the skewer produced the highest content of volatiles over time. Encapsulated flavors applied as marinades and liquid flavors coated onto the skewer performed equally well, while with liquid flavors used in the marinade only very low levels of volatiles were detected.

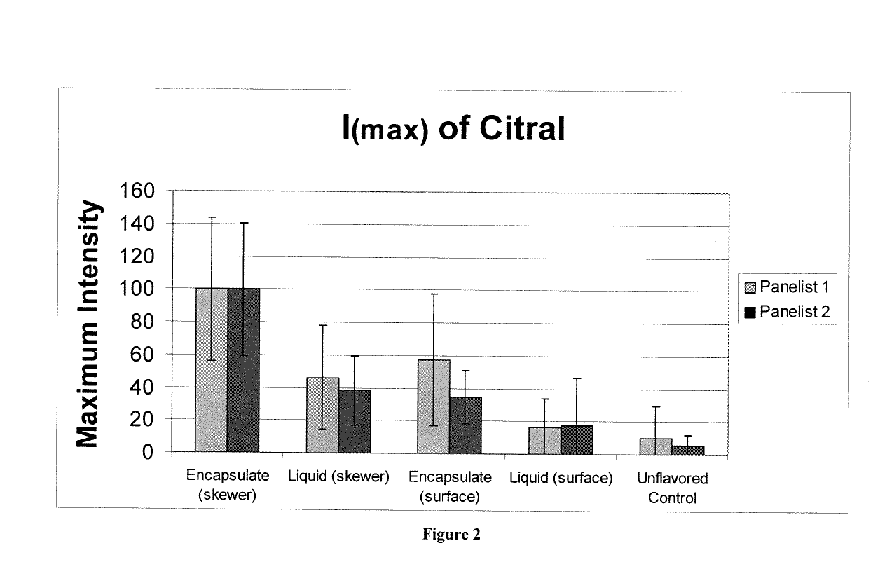

FIG. 2 shows the normalized maximum intensity value (I_{MAX}) obtained for a specific compound in the lemon flavor composition used in the samples, Citral, for both panelists. The values in FIG. 2 are calculated based on the mean of three individual measurements. Given differences depending on panelists, the data were normalized to identical highest values (at 100) for both panelists, thus only showing sample (A, B, C, D)-related effects. While the maximum Intensity was measured for a number of volatiles present in the lemon flavor composition, Citral was selected arbitrarily for FIG. 2. Other volatiles showed a similar or identical pattern and are, therefore, not displayed here.

FIG. 2 confirms the above results, in that the encapsulated flavor compound Citral produced highest intensity during consumption when it was present in the coating of a skewer. This was true for both panelists. Again, liquid flavors in the coating of the skewers and encapsulated flavors used in the marinade performed second best, while lowest intensity was measured when liquid flavor was used in marinades.

Surprisingly, food grilled on a skewer comprising a coating with flavor resulted in higher flavor intensity than food, which was marinated with the same amount of flavor.

What is claimed is:

1. A skewer for flavoring solid foods comprising a coating on at least a portion of the outer surface of the skewer, wherein the coating comprises an encapsulated flavor.

2. The skewer according to claim 1, wherein the flavor is present in the coating in an amount sufficient to flavor pieces of meat, chicken, seafood and/or vegetables during barbecuing, grilling, frying, and/or roasting.

3. The skewer according to claim 1, wherein the flavor is encapsulated in capsules selected from the group consisting of spray-dried capsules, extruded capsules, spray-granulated capsules, spray-agglomerated capsules, coacervates, core-shell capsules made by prilling, cyclodextrin encapsulated flavors (molecular inclusion), In Situ Micro Encapsulation (ISME), and yeast based capsules.

4. The skewer according to claim 1, wherein the flavor is encapsulated in a micro-organism.

5. The skewer according to claim 1, wherein the coating further comprises a film forming material.

6. The skewer according to claim 1, wherein the coating is water-based.

7. A method for preparing a skewer, the method comprising the step of applying a coating comprising an encapsulated flavor to at least a portion of the outer surface of the skewer.

8. The method according to claim 7, wherein the coating is prepared by the step of dissolving and/or suspending a flavor in a liquid.

9. The method according to claim 8, wherein the coating is prepared by further adding a film-forming material to the liquid.

10. A method of flavoring food, the method comprising the step of skewering the food onto the skewer as defined in claim 1.
